(19) United States
(12) Patent Application Publication
(10) Pub. No.: US 2005/0139246 A1
(43) Pub. Date: Jun. 30, 2005

(54) Support Arm

(76) Inventor: James Jacob Davidson JR., State College, PA (US)

Correspondence Address: James J Davidson Jr, #153, 610 Toftrees Ave, State College, PA, 16803, US

(21) Appl. No.: 11/007,983

(22) Filed: Dec. 8, 2004

Related U.S. Application Data
(60) Provisional application No. 60/527,158, filed on Dec. 8, 2003.

(51) Int. Cl. A61H 3/00

(52) U.S. Cl. 135/67

(57) ABSTRACT

A new anti tip safety attachment for ambulatory aids that provides the stability needed to help keep ambulatory aids from being inadvertently pushed or tipped over. The Support Arm is universal and comes in a pair with each set being comprised of a 2 piece leg clamp molded from non toxic polymer plastic, 4 steel screws and a support arm made of approximately 1″ anodized aluminum tubing with a rubber stopper on the end. The 2 piece leg clamps attach to the ambulatory aid with the support arm facing out and down with the rubber stopper at least 1″ from the walking surface. There is no need to engage The Support Arm once secured and it will fold with the ambulatory aid.

### CROSS REFERENCE TO RELATED APPLICATIONS

This application claims the benefit of the filing date of provisional application for patent Ser. No. 60/527158, filed Dec. 8, 2003 to The Support Arm by James J Davidson Jr.

### BACKGROUND OF THE INVENTION

The Support Arm concept was realized after the inventors Grandmother accidentally pushed her front wheeled walker over. The walker was pushed over leaving her without support and landed on and caused injury to her foot making it painful to walk. While operating her walker she inadvertently caused the back legs of her walker to come up causing the walker to balance on just the front wheels. Not realizing this she caused the wheels of the walker to roll backwards and the walker fell forward and down. The main function of an ambulatory aid is to remain upright in order to give the user the needed benefit of support.

### BRIEF SUMMARY OF THE INVENTION

The Support Arm is a new anti tip safety attachment for ambulatory aids to include but not limited to walkers and rollators. It provides the stability needed to keep ambulatory aids from being inadvertently pushed or tipped over causing unnecessary injury. The 2 piece leg clamp is easily tightened to the leg of the ambulatory aid with the support arm facing down and the rubber stopper on the end of the support arm at least 1″ above the walking surface. When the product is secured there is no need to engage it and it will fold with the ambulatory aid.

### BRIEF DESCRIPTION OF SEVERAL VIEWS OF THE DRAWING

FIG. 1 is a side view of the back piece of the leg clamp.

FIG. 2 is a side view of the front piece of the leg clamp with support arm post.

FIG. 3 is a top view of FIG. 1 and FIG. 2.

FIG. 4 is a side view of the aluminum support arm with rubber stopper.

FIG. 5 is The Support Arm shown attached to the front leg of a wheeled walker.

### DETAILED DESCRIPTION OF THE INVENTION

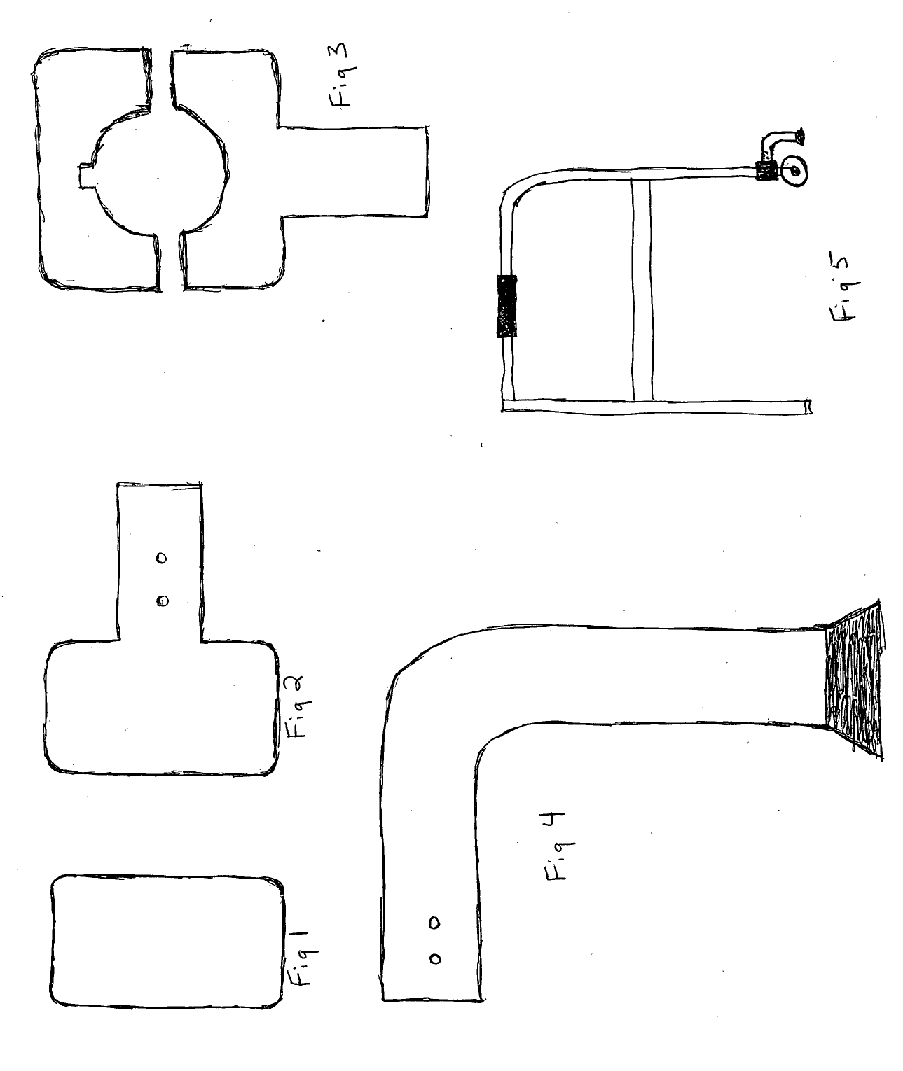

The Support Arm comes in a pair with each set being comprised of a 2 piece leg clamp (FIG. 1 and FIG. 2) molded from non toxic polymer plastic, 4 tightening screws, an L shaped support arm (FIG. 4) made of approximately 1″ anodized aluminum tubing with a rubber stopper on the end and a steel adjusting pin with pull ring. First secure the support arms (FIG. 4) to the support posts on the front clamps (FIG. 2) with the adjusting pins. You then loosely secure the back clamp (FIG. 1) to the front clamp (FIG. 2) on the leg of the ambulatory aid using the 4 screws making sure the front clamp (FIG. 2) with support arm post is facing out. Before fully securing the leg clamps (FIG. 1 and FIG. 2) to the legs be sure that the rubber stoppers are high enough off the walking surface so as not to impede movement of the aid, at least 1″. Once properly secured to the legs The Support Arm does not need to be engaged and they will fold flat with the aid.

1. What I claim as my invention is an attachment placed on an ambulatory aid, in specific a walker or rollator, to keep it from tipping over due to the ambulatory aid being pushed in a way to cause the ambulatory aid to balance on only one set of the ambulatory leg/s and or wheel/s of the ambulatory aid. The probability of the now unstable ambulatory aid falling over and causing injury is dramatically increased. The Support Arm performs a much needed task for the ambulatory aid operator while also providing peace of mind.
